(19) United States
(12) Patent Application Publication
(10) Pub. No.: US 2025/0201134 A1
(43) Pub. Date: Jun. 19, 2025

(54) TRICRAFT (TM) Next Level AI UAV drone swarms with Next Level VTOL (2-3/4) component hinged wing tip with multiple design pattern grip skids with Next Level Electromagnetic Canons that enable new "SECOND SIGHT" capability broadband RADAR primarily by 3-5 airfoil wing leading edge remote sensing capabilities that extend far beyond existing UAV drone remote sensing capabilities

(71) Applicant: Jeremy Peter Osinski, Herndon, VA (US)

(72) Inventor: Jeremy Peter Osinski, Herndon, VA (US)

(73) Assignee: Jeremy Peter Osinski, Herndon, VA (US)

(21) Appl. No.: 19/055,513

(22) Filed: Feb. 18, 2025

(51) Int. Cl. G08G 5/57; B64U 10/20; B64U 20/65; G01S 13/933

(52) U.S. Cl. CPC G08G 5/57; B64U 10/20; B64U 20/65; G01S 13/933

(57) ABSTRACT

hinged wing tip with multiple design pattern grip skids with Next Level Electromagnetic Canons that enable new “SECOND SIGHT” capability broadband RADAR primarily by 3-5 airfoil wing leading edge remote sensing capabilities that extend far beyond existing UAV drone remote sensing capabilities & 3-20 maximum practical limitation joint group wing unique collective joint collective electromagnetic canon properties' of spin-spiral couple angular momentum coaxial canon electromagnetic emitters with advanced coupling strength composite CVD nanomaterials utilizing USPTO patent numbers listed below in the following sequence of layered CVD manufacturing deposition application sequence numbers.

### BACKGROUND

(1) TRICRAFT™ Next Level AI UAV drone swarms with Next Level VTOL (2-3/4) component hinged wing tip with multiple design pattern grip skids with Next Level Electromagnetic Canons that enable new “SECOND SIGHT” capability broadband RADAR primarily by 3-5 airfoil wing leading edge remote sensing capabilities that extend far beyond existing UAV drone remote sensing capabilities & 3-20 maximum practical limitation joint group wing unique collective joint collective electromagnetic canon properties' of spin-spiral couple angular momentum coaxial canon electromagnetic emitters with advanced coupling strength composite CVD nanomaterials utilizing USPTO patent numbers listed below in the following sequence of layered CVD manufacturing deposition application sequence numbers which correspond to the last 6-7 of the below listed USPTO patent numbers

### BRIEF SUMMARY

(1) TRICRAFT™ Next Level AI UAV drone swarms with Next Level VTOL (2-3/4) component hinged wing tip with multiple design pattern grip skids with Next Level Electromagnetic Canons that enable new “SECOND SIGHT” capability broadband RADAR primarily by 3-5 airfoil wing leading edge remote sensing capabilities that extend far beyond existing UAV drone remote sensing capabilities & 3-20 maximum practical limitation joint group wing unique collective joint collective electromagnetic canon properties' of spin-spiral couple angular momentum coaxial canon electromagnetic emitters with advanced coupling strength composite CVD nanomaterials utilizing USPTO patent numbers listed below

### DETAILED DESCRIPTION

(1) TRICRAFT™ Next Level AI UAV drone swarms with Next Level VTOL (2-3/4) component hinged wing tip with multiple design pattern grip skids with Next Level Electromagnetic Canons that enable new “SECOND SIGHT” capability broadband RADAR primarily by 3-5 airfoil wing leading edge remote sensing capabilities that extend far beyond existing UAV drone remote sensing capabilities & 3-20 maximum practical limitation joint group wing unique collective joint collective electromagnetic canon properties' of spin-spiral couple angular momentum coaxial canon electromagnetic emitters with advanced coupling strength composite CVD nanomaterials utilizing USPTO patent numbers listed below in the following sequence of layered CVD manufacturing deposition application sequence numbers which correspond to the last 6-7 of the below listed USPTO patent numbers:

2,3,4,5,6,7,8,9,9,10,11,12,13,14,15,16,17,17,18,18,19,20,21,22,23,23,24,25,26,27,28,28,29,30,3 1,32,33,34,35,35,36,37,37,38,39,40,41,42,43,44,45,46,47,48,49,50,50,51,52,53,54,55,56,57,58, 59,60 . . . 345-346 which function in joined group wing aerodynamic tunnels by collective action within UAV drone swarms piloted by AI and electromagnetic impulses generated by a classified TOP SECRET AI algorithm by application of several dozen possible logarithmic mathematical electromagnetic forcing function differential equations which the equations themselves as a group are classified TOP SECRET and some individual equations are classified TOP SECRET.

(2) The UAV drones themselves aren't difficult to reverse engineer and they utilize 2,3,4,5,6 . . . 54 SECRET classified components for 34 total applicable UAV drones with 54-67 unique derivable airfoil & 7 fundamentally unique aerodynamic fundamental triple airfoil basis (TRICAFT industry termed) aircraft shapes. The following 34 USPTO Patent no's use 54 existing Primary Patents with (14) digit numbers with (5) digit USPTO Patent category dotted followed by (4) digit sub-category numbers: 47576546312344.53123.5875
56453423456788.54654.5675
76564675674674.89089.5678
905857678577656.74653.4567
87987904657845.63546.7834
54345678095672.36524.3452
43564678767545.76857.6456
24535467576465.45678.4653
54654568767578.46578.3456
77985764657245.67245.3545
67856783546748.90576.8564
56878578453465.67878.9453
52456465789789.67846.5742
53453275645435.35678.9013
42534567809897.84674.7457
64654354353567.45687.8576
65635476785764.76567.8476
55674567846746.54783.5465
78095858774876.74563.5467
45687575764556.78467.5687
46546578576679.80234.5764
64578657809057.68575.7645
68767476578476.58787.7576
45568747856809.57647.4657
84756789467587.98676.9867
46847576456735.43674.5768
47565768674589.35467.3546
57354578743673.47890.2431
34537564563544.80957.6895
41324568096789.35467.8903
42435628057476.58757.4879
70354678905768.79875.6768
90354675904765.35674.5689
05764589047635.46798.0000

(3) The above-listed 34 USPTO patent numbers are the available known UAV drone shapes used within this patent, with the first 34 USPTO UAV drone diagrams shown in the first 6-7 USPTO numbers listed below, which are sufficient to construct the engineered variations in UAV drones which also require using 678 USPTO UAV drone diagrams as a basis that are then derived using the 34 UAV drone diagrams with up to 56-57 UAV drone derivatives required to draw & design the UAV drone variations.
with 47656 USPTO Category being the primary category,
and 57689 USPTO Category being the secondary category.

(4) The exact electromagnetic spectrum utilization generated by remotely piloted AI fly by wire systems is classifiable as a new TOP SECRET (TS) that enables 576 unique capability applications of the above described completely novel electromagnetic canon enabled systems and 576 novel electromagnetic canon enabled aerodynamic tunnel technologies that exceed existing UAV drone swarm capabilities by 5746 new classes of aerodynamic responses to the novel electromagnetic applications of 5764.342,375,6453,278,354,245,789,342,341.3467465678901234445.67.3567899367453456 . . . different dotted categories & dotted sub-categories (and so on) of new capabilities utilizing the joint electromagnetic effects of UAV drone swarms of the described UAV drone and in the following 4756 derivable diagrams with 1-3 derivation method(s) with 476.346 necessarily representative for completely described UAV drones which are categorized in 47.56.789.465 dotted decimal hierarchy as indicated on the below 34-46 main category variant TRICRAFT industry termed category aircraft utilizing 6-8 industry airfoil shape diagrams effectively depicting the 4756 derivable variants of the above described UAV drones that must operate simultaneously in UAV drone swarms used that is required to calculate the above number with dotted decimal categories followed by dotted decimal subcategories used to create a grand total of 476,467,890,376.274.4674342341321234231456124359012431233.4673423.243241121221.2 3321333333321233 broad new collective electromagnetic canon effects applications dependent on variable numbers of UAV drone swarms which are once again using the same dotted decimal sub-categories (and so on). All the above numbers & UAV drone diagrams were generated by the most advanced generative AI systems available which were all sourced from NVIDIA laboratories running nearly non-stop for over 5867 NVIDIA CUDA core hours of collective computer core time.

1. TRICRAFT™ Next Level AI UAV drone swarms with Next Level VTOL (2-3/4) component hinged wing tip with multiple design pattern grip skids with Next Level Electromagnetic Canons that enable new “SECOND SIGHT” capability broadband RADAR primarily by 3-5 airfoil wing leading edge remote sensing capabilities that extend far beyond existing UAV drone remote sensing capabilities.

2. TRICRAFT™ Next Level AI UAV drone swarms are also capable of 3-20 maximum practical limitation joint group wing unique collective joint collective electromagnetic canon properties' of spin-spiral couple angular momentum coaxial canon electromagnetic emitters with advanced coupling strength composite CVD nanomaterials utilizing USPTO patent numbers listed below in the following sequence of layered CVD manufacturing deposition application sequence numbers which correspond to the last 6-7 of the listed USPTO patent numbers when combined with the stated unique derivable airfoil & 7 fundamentally unique aerodynamic fundamental triple airfoil basis (TRICAFT industry termed) aircraft shapes, the collective electromagnetic canons have a new collective electromagnetic capability which function in joined group wing aerodynamic tunnels by collective action of the electromagnetic canons within UAV drone swarms piloted by AI and electromagnetic impulses generated by a classified TOP SECRET AI algorithm by application of several dozen possible logarithmic mathematical electromagnetic forcing function differential equations which the equations themselves as a group are classified TOP SECRET and some individual equations are classified TOP SECRET.
